(19) United States
(12) Patent Application Publication
(10) Pub. No.: US 2019/0206249 A1
(43) Pub. Date: Jul. 4, 2019

(54) Collision awareness and emergency signal system

(71) Applicant: Juan Manuel Medina, Tijuana (MX)

(72) Inventor: Juan Manuel Medina, Tijuana (MX)

(21) Appl. No.: 15/999,888

(22) Filed: Aug. 27, 2018

Related U.S. Application Data
(60) Provisional application No. 62/708,921, filed on Dec. 29, 2017.

(51) Int. Cl. G08G 1/0965

(52) U.S. Cl. CPC G08G 1/0965

(57) ABSTRACT

A screen device installed inside vehicles and trucks, which can be used for many ways of communication. It is comprised of a set of small screens, buttons, speakers and a microphone, which can be used to broadcast a series of signals and alerts between authorities and drivers. The screen device will be connected to a satellite network and all signals coming out of a vehicle will include location coordinates thus giving all receivers the ability to calculate the distance from the broadcasting device. Radio Frequency will be used as the main wireless communication channel since it does not depend on a network to be available and transmitted. At least two collision detection devices will be installed on vehicles and trucks, which will automatically trigger a collision alarm to other drivers, thus preventing further accidents. A variety of buttons will be used to establish communication and information between driver and authorities or other drivers in order to alert each other of emergency events.

### CROSS-REFERENCE TO RELATED APPLICATIONS

This Application claims benefit of provisional patent Ser. No. 62/702,921 Filed Dec. 29, 2017 by the present inventor.

### FEDERALLY SPONSORED RESEARCH

Not Applicable

### SEQUENCE LISTING OR PROGRAM

Not Applicable

### BACKGROUND

### Field of Invention

This Invention relates and is aimed at preventing accidents by a screen device that will be installed in the transport unit interior, forming a communication network between vehicles, loading trucks and police units.

Likewise, through this innovative screen devices, road authorities communication network between drivers will improve enormously.

### Prior Art

It has been more than 100 years since the invention of the automobile. Ever since then there have been numerous accessories invented to be used inside and outside vehicles with the purpose of providing more security and comfort to the drivers and passengers. However, no invention to improve the communication between drivers and authorities or other drivers has reached the industry, while the amount of accidents and fatalities involved keeps increasing every year.

Currently, the communication through sirens and stroboscopic lights used by police officers even though they alert you of an emergency situation they generate a lot of confusion between drivers. The only message other drivers understand is that they need to get out of the way, but sometimes they do not even know the source of the sound, causing even more confusion which can even lead to more accidents, especially when drivers are located in intersections.

It is very dramatic to see how during a pursuit police officers drive at very high speeds in the middle of roads and freeways regardless of the amount of traffic. Other drivers, not too far away, cannot hear the sirens yet, so they cannot be alerted of such dangerous situation which may be coming their way.

There are also other very dangerous situations where a vehicle is stalled in the middle of a road due to mechanical problems and other drivers are not aware, causing terrible accidents. These drivers sometimes have no way to alert other drivers and getting off the vehicle can expose them to an even more dangerous situation.

Police officers are also exposed to a very dangerous situation when doing vehicle inspections in the road. They stop a vehicle, get off the police car and suddenly another vehicle crashes against them. There are numerous cases where police officers lost their life in these types of accidents which could have been prevented.

Weather hazards also create very dangerous situations. There are numerous cases where even hundreds of vehicles have been involved. When due to snow, rain or fog drivers have limited visibility which prevents drivers from being aware of dangers ahead of them. It is very frustrating to see how vehicles keep crashing and there seems to not be a way to alert them. By the time the drivers notice the danger it is too late, causing more and more vehicles to crash against other vehicles which already crashed previously. It ends up being a complete tragedy just because there was no way to alert the drivers about the first accident in the road.

Due to the gravity of these accidents, where the drivers often end up unconscious and unable to emit an alarm, the Automatic Alarm Signal was designed as a way to trigger automatically and alert other drivers. This signal and how it gets produced and transmitted will be described further.

Another event that can be improved with the use of the screen device is the report of felonies or emergencies. Currently, when there is a felony or emergency, a person dials 911. The person on the other end has to effectively request the location of the event, locate the closest officer and transmit the said location. During this process, valuable minutes can be lost which can represent a life or death situation.

With the Collision Awareness and Emergency Signal System “CA&ESS” officer can be alerted directly and notified of the location in real time, thus helping them respond more efficiently.

Additionally another feature of the “CA&ESS” is the direct communication from police officers using the Authority Alert Screen with the Drivers Alert Screen located in other vehicles which will allow, for the first time in history, the said police officers to provide instructions to the said drivers inside the vehicle during emergency situations even if there are miles from the location.

This new invention “CA&ESS” will create an unprecedented new type of communication, with the use of analog and digital signals as well as the way police officers will communicate with the population, which can represent a new generation of automobiles. With this new way of communication between authorities and drivers many accidents will be prevented, thus saving thousands and eventually millions of lives.

If we take into account the above the CA&ESS invention is totally new and unique.

Here are some of the previously patented Technologies described as prior Art:

Technology by Christoper N. Day, presented in U.S. Pat. No. 9,307,217 B1, for the “Portable Video Camera/Recorder Having Video Security Feature”. This invention can transfer video recorded directly through a wireless protocol to another device without the need to extract the information with a storage device. This can be done by activating a button located on the driving wheel of the vehicle or the user key holder, etc. This system automatically loads a previously recorded session from the second sequence of the video of the said memory to a user device.

As we can see, the invention above is limited to extracting video information wirelessly from another device by pressing a button. Its use is very limited and specific since the only data flow network is between the video camera, the activation button and the receiver device. Other limitation of this invention are its lack of alerts such as sounds and lights, a voice communication channel and its lack of integration with other vehicles on its network.

Technology by Jacky Lu Presented in patent No. US 20160381292 A1, and whose invention consist in a dash camera which holds an accelerometer connected to a CPU. If the said CPU detects an acceleration above a previously set value it shuts off the power supply of the storage device in order to protect the data stored. In case of a collision, the accelerometer generates a strong signal by detecting the G-force and it is received by the CPU which instantly blocks the storage in order to protect the data. Additionally this system comprises a pair of wide angle lenses which generate a 320 degrees view which is focused on the direction of the vehicle and against it, which helps record and store images from inside and outside the said vehicle.

As we can see, one of the applications of this device is to protect information stored in the vehicle in case of an accident, which makes this system a simple fuse like system. Additionally the wide angle on the camera is designed to record as much information and possible. Based on this, it is very clear the purpose of this invention is to collect and protect the data, but never to assist the driver in case of an emergency.

Technology by Anil K. Shahai presented in patent No. WO 2005091744 A2. This invention consists on a cell phone application which connects to a receiver located in the vehicle with the purpose of controlling some functions of it. These functions can be the activation of a light, blocking the starting of the engine, etc. This invention generates a link between the device inside the vehicle and a operator outside of it and helps control certain functions previously programmed. The main purposed of this invention is to utilize it when the vehicle is stopped or off, not when the vehicle is in motion. Based on this, this invention is not intended to assist in the driver in any way in case of an emergency, especially while driving which is when it is needed the most. Additionally, this technology is limited by the fact that the communication is only between the cell phone and the device inside the vehicle, without the intention of being integrated with other devices for more capabilities or to interact with devices on other vehicles.

The invention U.S. Pat. No. 3,939,418 A submitted by Howard J. Morrison, Albert G. Keller comprises a generator of audible signals of different frequencies in response to an actuator manually activated by hand. When the walkie-talkie is in transmission mode the signal is transmitted to another walkie-talkie and when it is in receiver mode the signal is amplified by the same generator. It is clear that this invention is designed to be a selector of audible signals which works by selecting the proper frequency, but provides no additional functionality such as connecting to police frequencies or transmitting any other data.

Technology by patent U.S. Pat. No. 7,072,622 B2, by Jany-Yee Hsu, Chau-Kai Hsieh. This invention comprises a Continuous Tone-Coded Squelch System (CTCSS) which works by controlling the transmission of signals.

When used in a Walkie-Talkie device, it adds a low frequency audio tone to the voice in order to filter out noise in the signal. It Works by muting those users who are using a different CTCSS tone or no CTCSS. As we can see this is a system designed to filter audio transmitted on a RF signal and its sole purpose is to provide a communication channel of better quality, it does not add any other type of data.

Technology by patent No. 20070291664-A1, by Daniel Weyl, Karl-Ernst Steinberg. This invention utilizes a mobile phone to communicate with a device installed inside a vehicle using Bluetooth technology. Through the use of communication channel the vehicle extracts a list of telephone numbers which are shown on a display installed in the said vehicle. The purpose is to give control of the use of the contacts through buttons and the touch screen on the vehicle in order to prevent the user from interacting directly with the cell phone. As we can see, this invention utilizes a previous invention (Bluetooth) as its means or wireless communication, which means the only innovation is the use of a Software with the sole purpose of transmitting a list of contacts on the same vehicle where the phone is connected. It is not designed to provide any sort of emergency assistance or to connect to any external wireless network.

Invention U.S. Pat. No. 5,515,043 A, by Alfredo J. Berard, James L. Mentzer, David C. Nixon. This invention comprises a system of localization and alarm activation. It also provides a function where it dials a list of predefined telephone numbers in order to alert the owner when the alarm is activated as well as an access to remotely connect to the vehicle with the purpose of allowing certain functions such as disabling the said vehicle. This device makes use existing technologies such as anti-theft alarm, GPS and either a mobile phone line or an internet connection in order to communicate the event, which makes this invention mostly about Software. It is clear that this invention is designed as an anti-theft system and has no intention to assist the driver in case of an outside emergency as well as to transmit alerts to other vehicles. This invention also lacks any sort of interaction with authorities. As an important note, this invention may also act the opposite of preventing accidents, since it allows disabling the vehicle while in motion which can cause it to become a dangerous situation for other vehicles.

### DRAWINGS_FIGURES

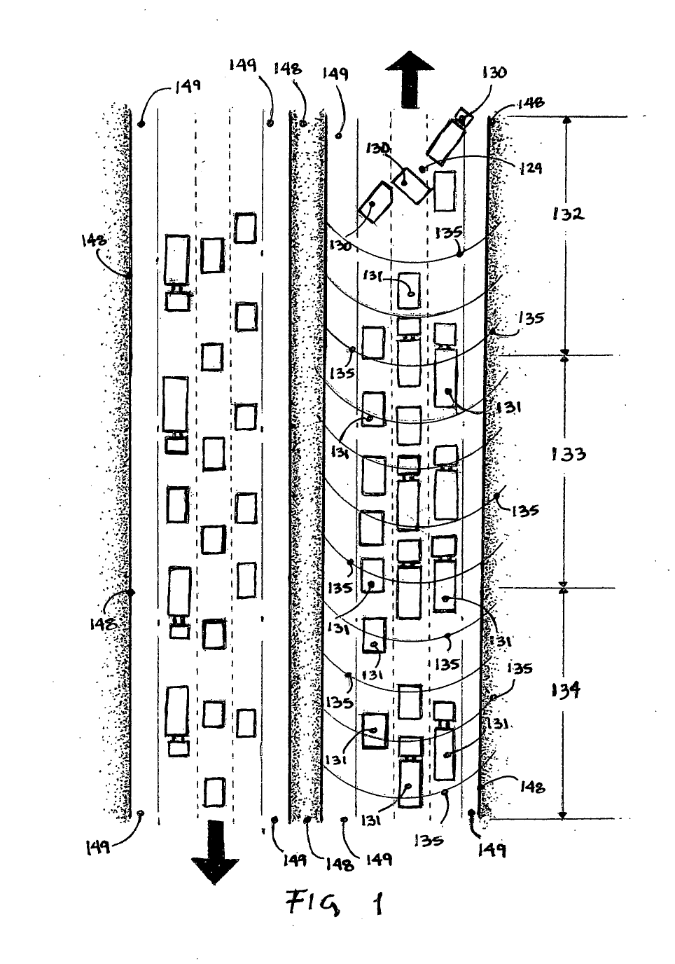

FIG. 1 Collision Point in Freeway Signal Reception Areas.

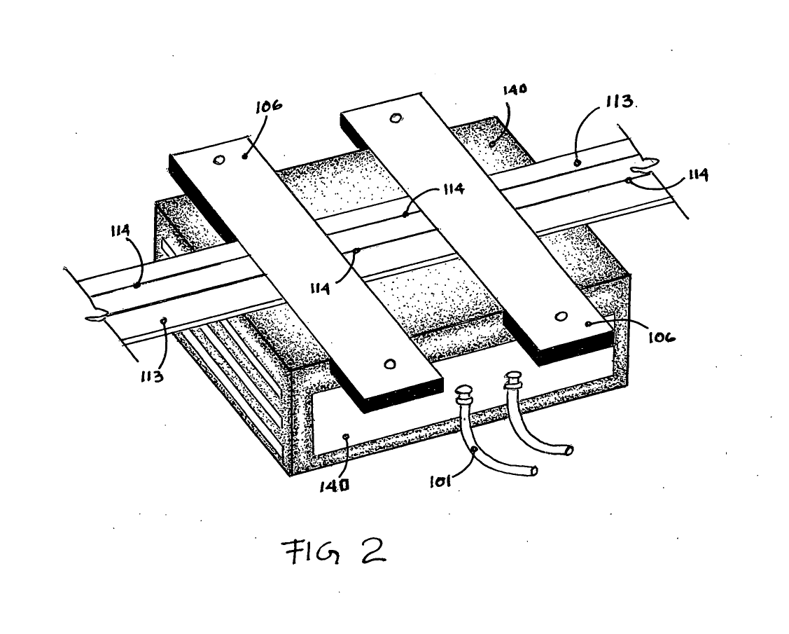

FIG. 2 Collision Detector Device.

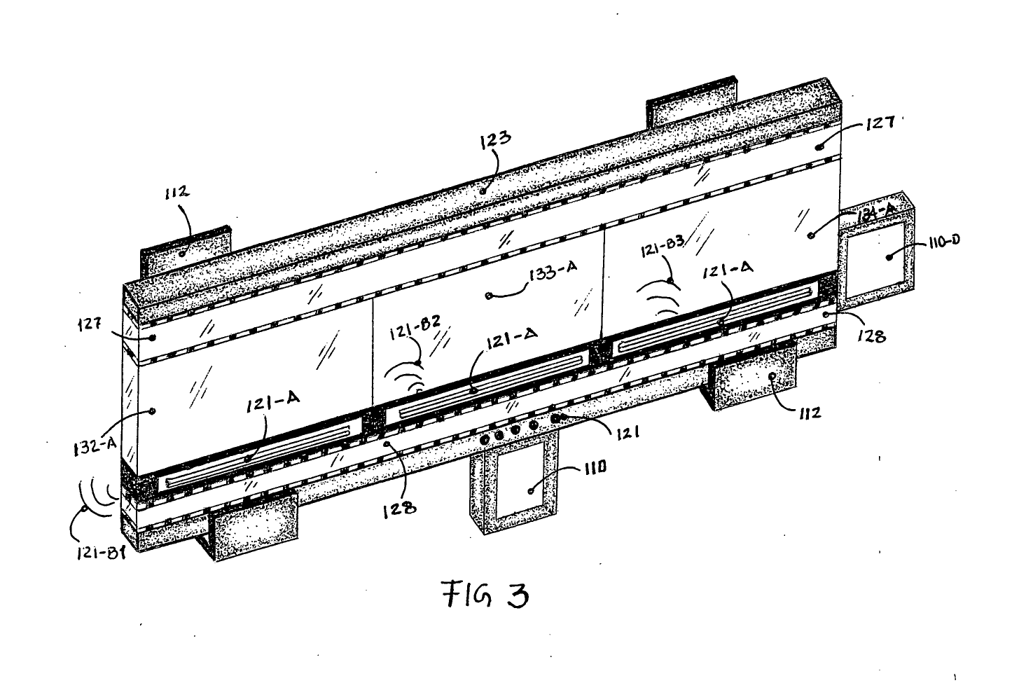

FIG. 3 Drivers Alert Screen

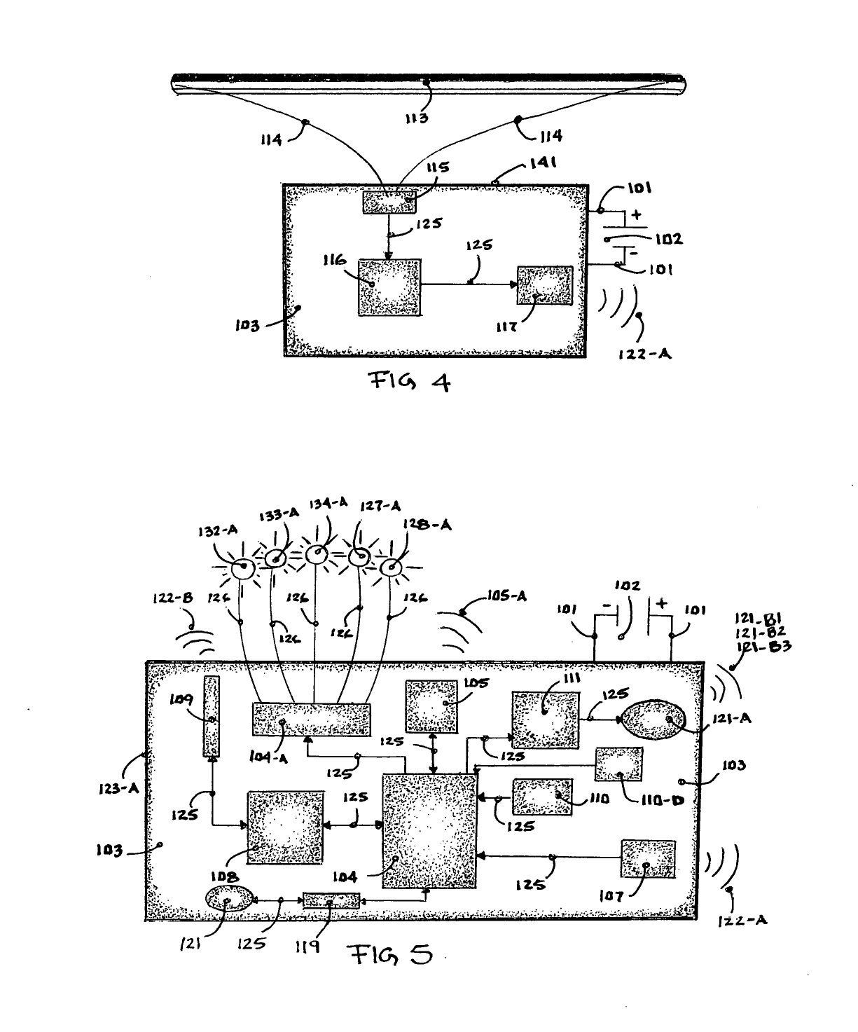

FIG. 4 Collision Detector Electronic Module

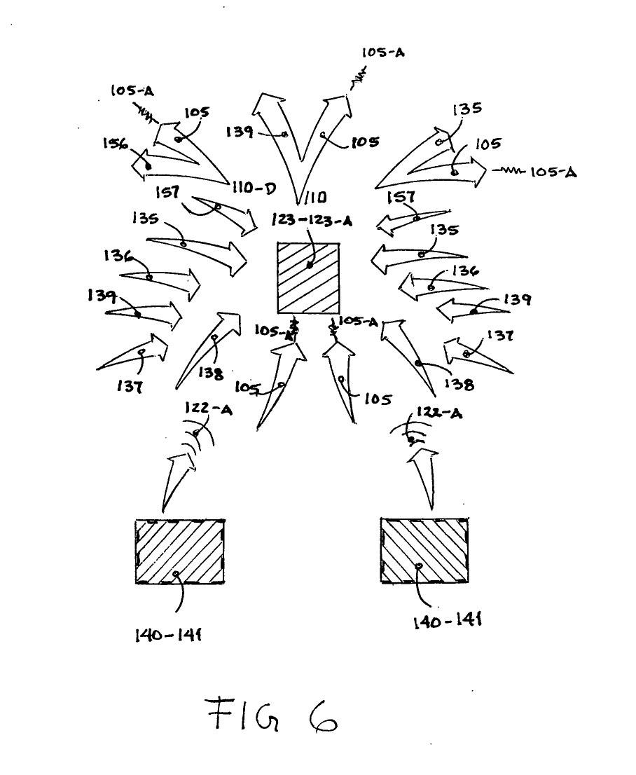

FIG. 5 Drivers Alert Screen Electronic Module

FIG. 6 Distribution and Direction of Drivers Signal

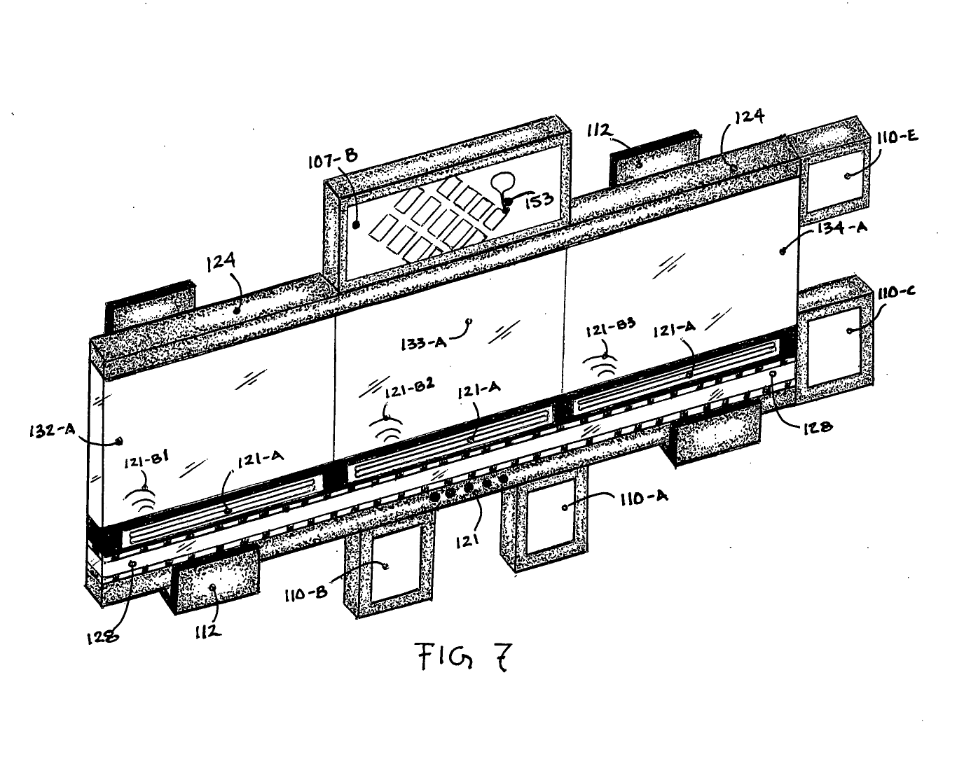

FIG. 7 Authority Alert Screen

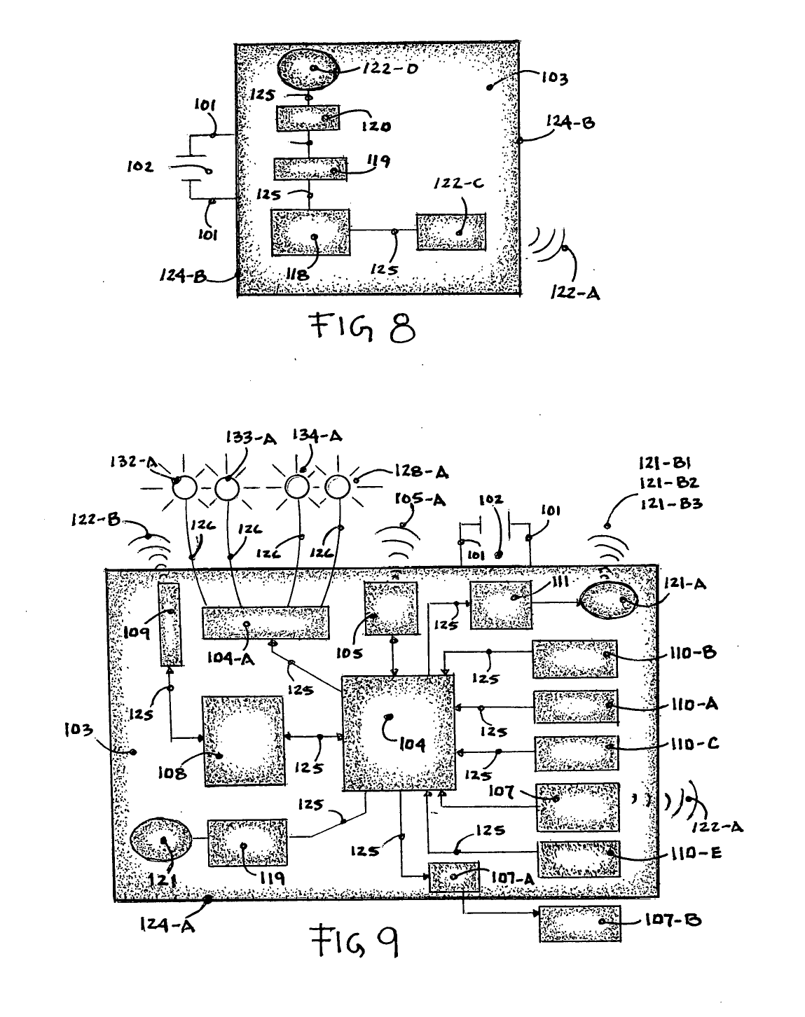

FIG. 8 Authority Wireless Control Unit Extension. Electronic Module

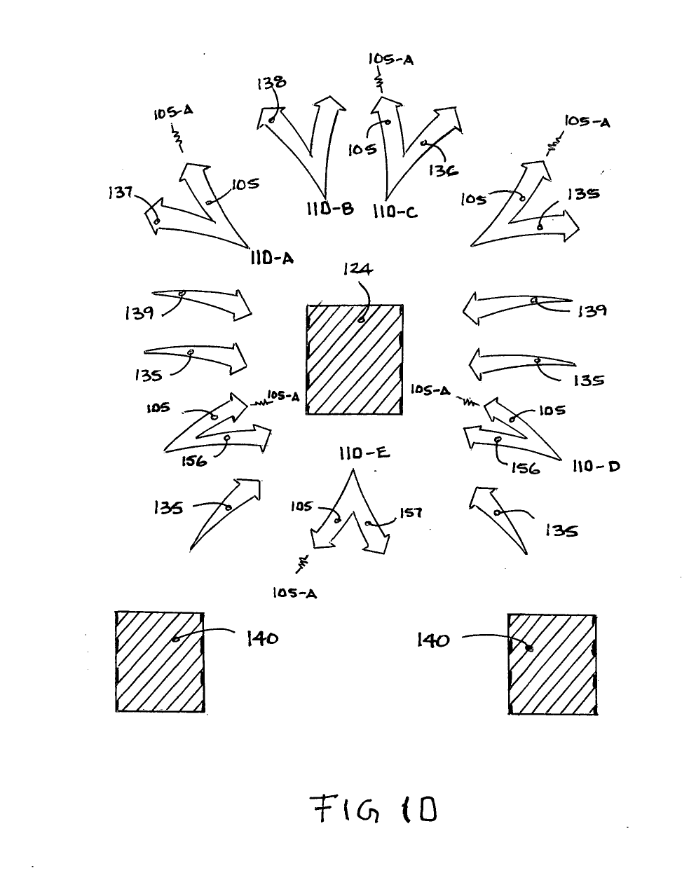

FIG. 9 Authority Control Unit Electronic Module.

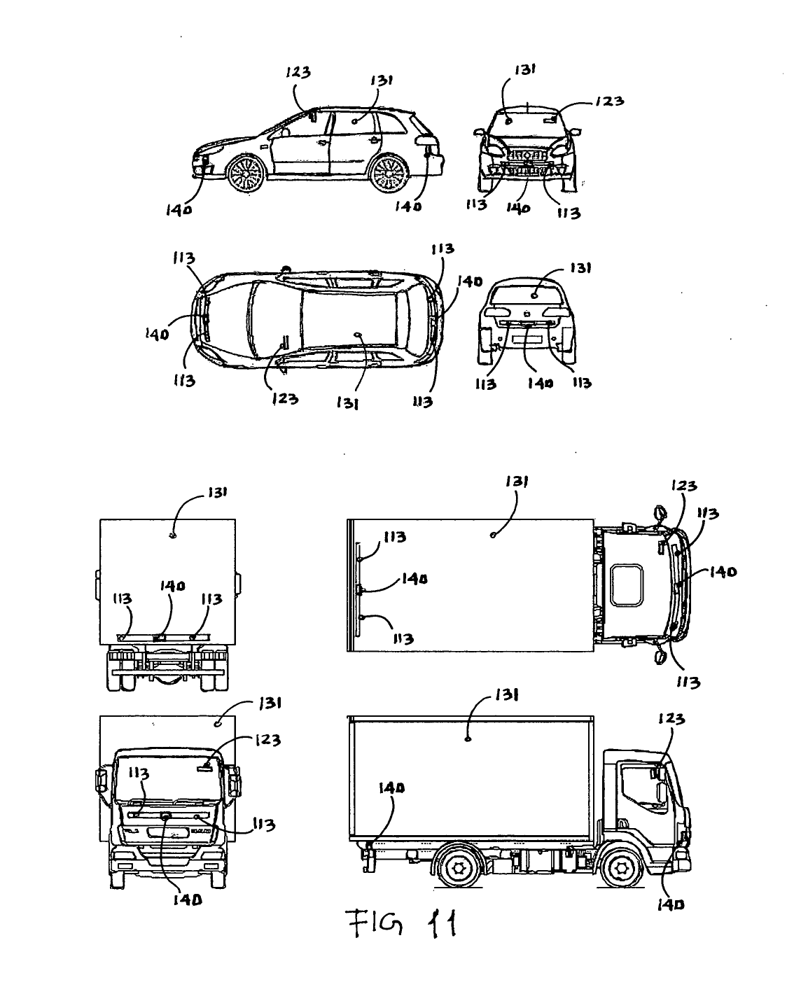

FIG. 10 Distribution and Direction of Authority Signal.

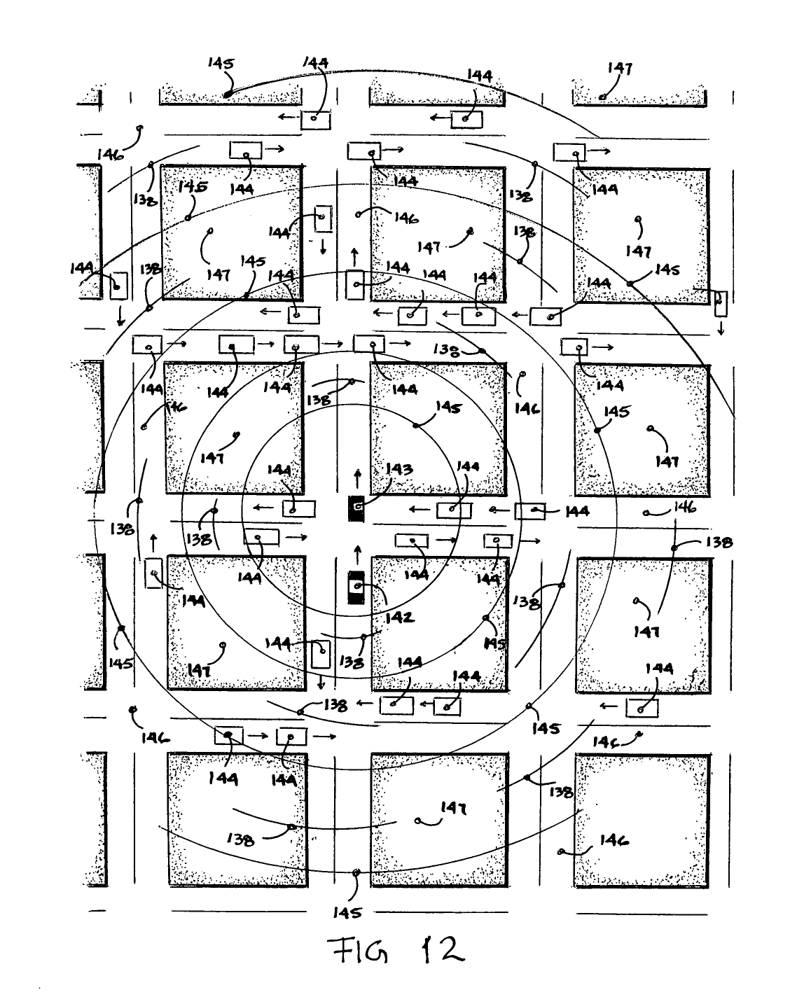

FIG. 11 Sender-Receiver and Collision Band Detector In Cars And Trucks Location

FIG. 12 Pursuit Signal Distribution

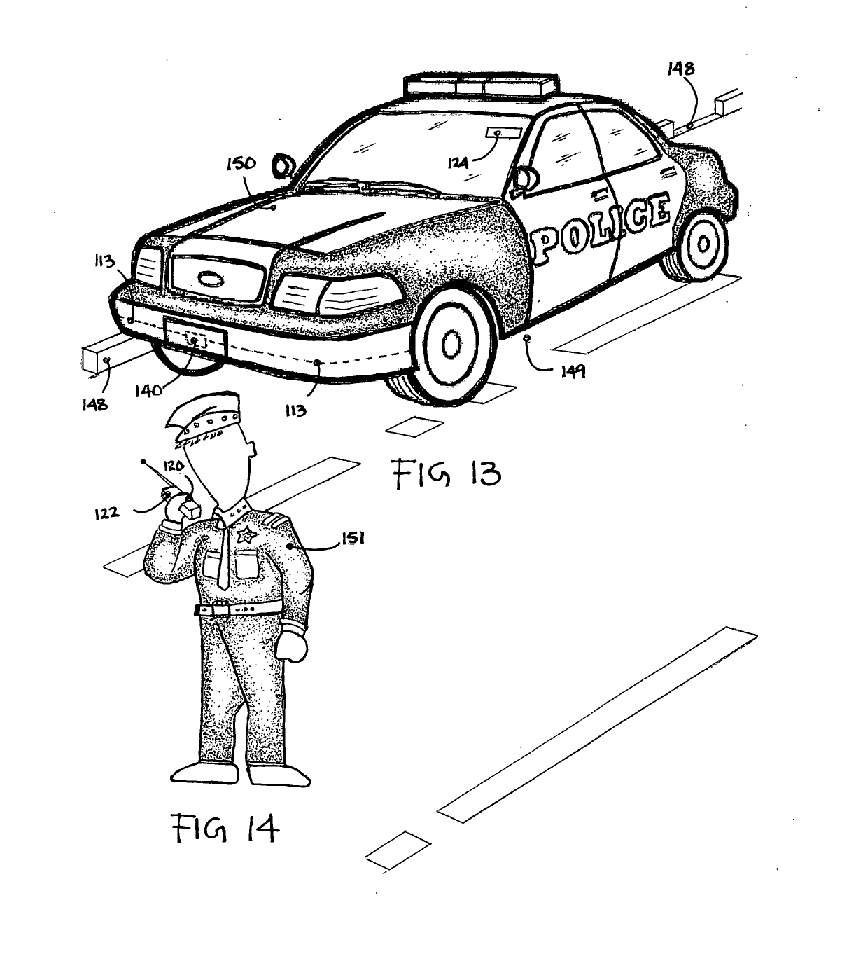

FIG. 13 Authority Car

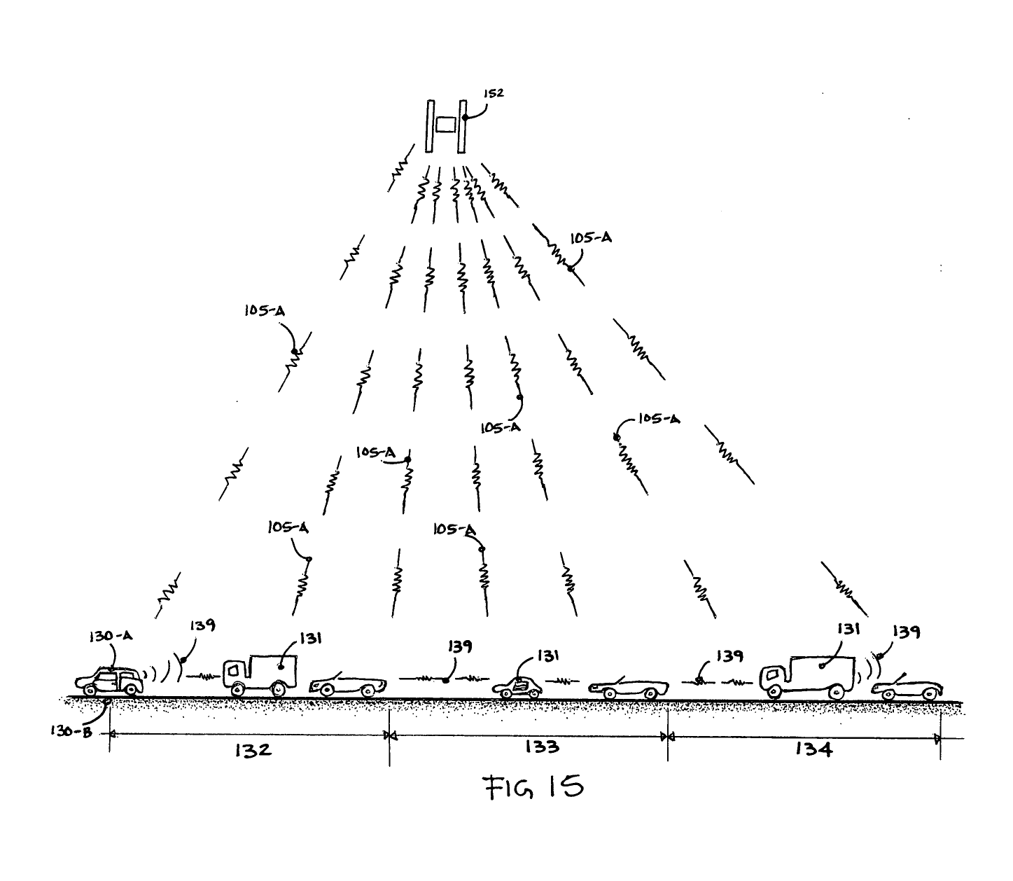

FIG. 14 Law Officer

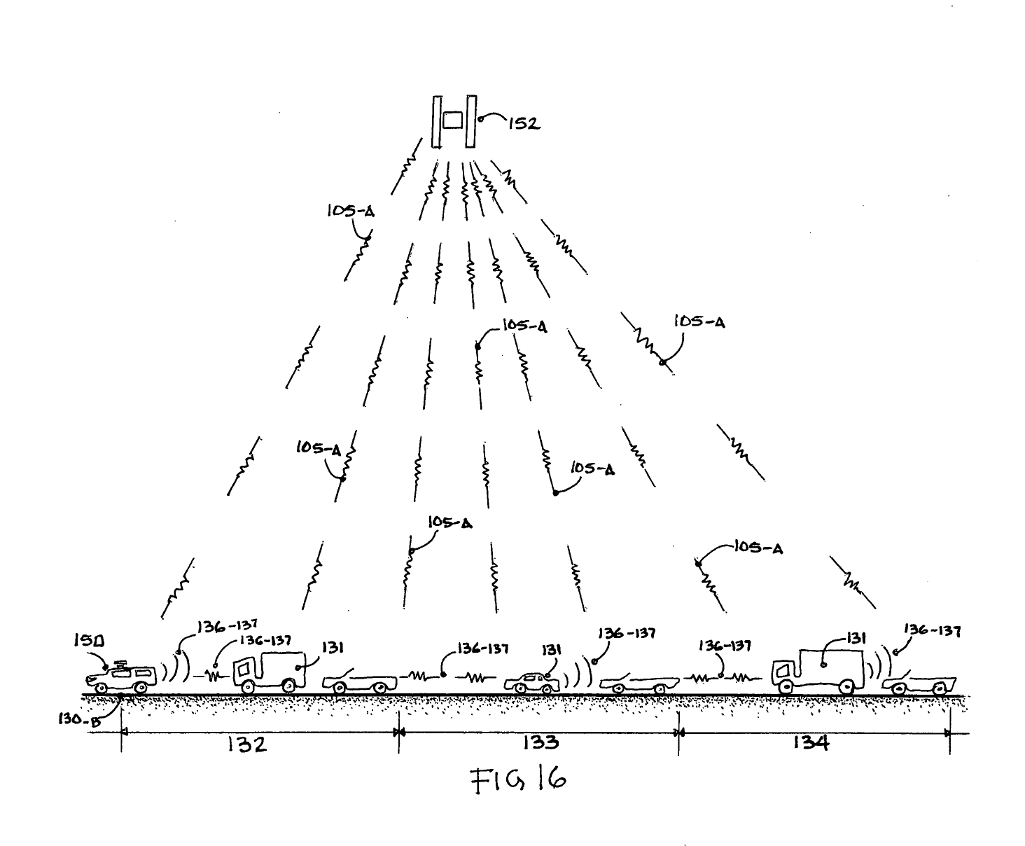

FIG. 15 Drivers Manual Signal and GPS Net

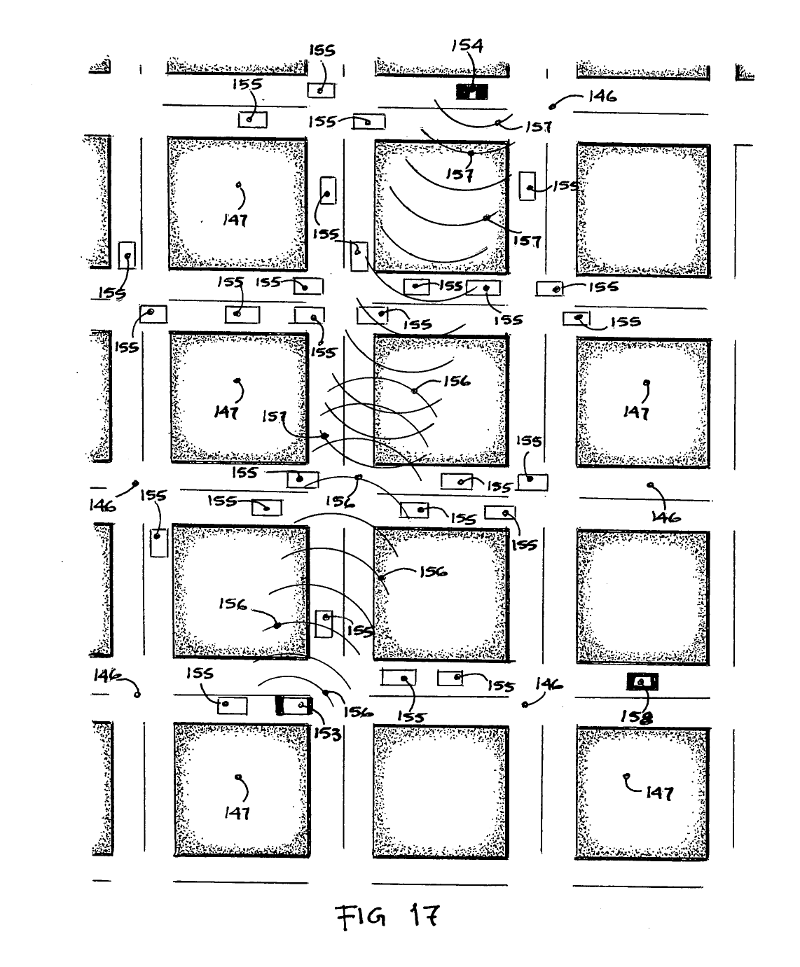

FIG. 16 Authority Signal and GPS Net

FIG. 17 Felony Report

### DRAWINGS_REFERENCE NUMERALS

101 Power Feeder Cable
102 Battery
103 Electronic Board
104 CPU
104-A Lights Controller
105 GPS Device
105-A GPS Coordinates Signal
106 Fixer to the Car
107 Internal Network Wireless Device
107-A Display Controller
107-B Display
108 RF Transceiver
109 Antenna
110 Alert Button
110-A Lineal Authority Emergency Button
110-B Circular Signal Authority Pursuit Button
110-C Authority Traffic Stop Button
110-D Felony Report Button
110-E Authority Felony Report Button
111 Digital to Analog Converter
112 Screen Holder
113 Collision Detector Band
114 Collision Detector Band Signal Wires
115 Analog to Digital Converter
116 Microprocessor
117 Wireless Device Collision Detector
118 Authority Microprocessor
119 Authority Analog to Digital-Digital to Analog Converter
120 Microphone Switch
121 Microphone
121-A Speaker
121-B1 High Sound
121-B2 Medium Sound
121-B3 Low Sound
122 Authority Wireless Microphone Extension
122-A Internal Wireless Network
122-B External Wireless Network
122-C Authority Wireless Device
122-D Wireless Device Microphone
123 Structural Body of the Drivers Alert Screen
123-A Drivers Screen Electronic Module
124 Structural Body of the Authority Alert Screen
124-A Authority Screen Electronic Module
124-B Authority Wireless Electronic Module Unit Extension
125 Signal Direction
126 Light Wires
127 Stroboscopic Light
127-A Red-blue Color Light
128 Drivers Collision Light (Orange Color)
128-A Orange Light
129 Initial Collision Point
130 Crashed Vehicles
130-A Vehicle Producing a Manual Signal
130-B Alerting Vehicle Location
131 Vehicles and cargo trucks Receiving Warning Signal
132 Emergency Zone (Screen Red Color)
132-A Red Light on Electronic Module
133 Critical Zone (Screen Yellow Color)
133-A Yellow Light on Electronic Module
134 Alert Zone (Screen Blue Color)
134-A Blue Light on Electronic Module
135 Automatic Collision Alarm Signal
136 Authority Manual Signal
137 Lineal Voice Main Signal
138 Circular Voice Main Signal
139 Manual Drivers Signal
140 Collision Detector Device
141 Collision Detector Electronic Module
142 Authority Car on Pursuit
143 Vehicle under Pursuit
144 Nearby Drivers
145 Vehicle under Pursuit Signal
146 Streets on Metropolitan Areas
147 Blocks
148 Freeway Division
149 Emergency Lines
150 Police Officer Vehicle
151 Law officer
152 Satellite
153 Vehicle Reporting Felony
154 Nearby police Officer Car
155 Vehicles on Transit
156 Felony Report Signal
157 Police Officer Responding For Help
158 Felony Event

### DETAILED DESCRIPTION—FIG. 1 THROUGH FIG. 17—PREFERRED EMBODIMENT

The preferred embodiment of the “Collision Awareness and Emergency Signal System” CA&ESS is composed of 4 Electronics Devices:

The First Electronic Device Will Be:

The Drivers Alert Screen

The Structural Body of the Drivers Alert Screen (123) FIG. 3 is installed inside the vehicles and mounted through Screen Holder (112) FIG. 3, in a visible and reachable location for the driver FIG. 11. The said Structural Body of the Drivers Alert Screen (123) FIG. 3 comprises 5 screen sections: The first section will be used to receive signals and indications from an Authority, Stroboscopic Light (127) FIG. 3. The second section will be the Blue Light on Electronic Module (134-A) FIG. 3, FIG. 5. The third section will be the Yellow Light on Electronic Module (133-A) FIG. 3, FIG. 5. The fourth section will be the Red Light on Electronic Module (132-A) FIG. 3, FIG. 5. And finally, the Fifth section will be the Drivers Collision Light (128) (Orange Color) FIG. 3, which will be activated through the Automatic Collision Alarm Signal (135) FIG. 1, only when a collision has occurred in an area detected by the system and represents a more dangerous situation.

Additionally, in the said Structural Body of the Drivers Alert Screen (123) FIG. 3, there are two buttons. The first one is the Alert Button (110) FIG. 3, FIG. 5, which is pressed by users to emit alerts of risks in the road, such as vehicles with a mechanical problem, flat tire, and objects in the road, etc. with the purpose of preventing accidents with the said vehicle or object in the road. The second button is the Felony Report Button (110-D) FIG. 3, FIG. 5, which is pressed by users to report a felony they are aware of and at the same time transmit the location coordinates, thus helping authorities respond more efficiently by allowing them to automatically know the location of the event which can be known by police officers in the area. This saves precious time between the moment a person dials 911, provides the address, and the closest officer is contacted. This process is described in detail in the operation of Felony Report FIG. 17.

Furthermore, the said Structural Body of the Drivers Alert Screen (123) FIG. 3 comprises three speakers (121-A) FIG. 3, which produces the following different sounds: High Sound (121-B1), Medium Sound (121-B2) and the Low Sound (121-B3) FIG. 3, FIG. 5. These sounds represent the distance between the device emitting the alert signals and the device receiving them. These signals will be: the Automatic collision Alarm Signal (135) FIG. 1, Manual drivers Signal (139) FIG. 15, and Authority Manual signal (136) FIG. 16, Lineal Voice main Signal (137) FIG. 16. Additionally, these sounds are synced with the three screen sections (134-A), (133-A), (132-A) FIG. 3, with the purpose of making easier for other drivers to know the distance and type of alarm, thus helping them make a better decision.

Additionally, the said Structural Body of the Drivers Alert Screen (123) FIG. 3, will include a Microphone (121) FIG. 3, which is activated when pressing the said Felony Report Button (110-D) FIG. 3, FIG. 5, in order to allow voice communication between the person reporting the felony (153) and an authority responding to it (154) FIG. 17.

The internal components of the said Structural Body of the Drivers Alert Screen (123) FIG. 3 are comprised by the Drivers Screen Electronic Module (123-A) FIG. 5, which is built on the Electronic Board (103) is powered by the Feeder Cable (101) and Battery (102) FIG. 5.

The said Electronic Board (103) comprises a CPU (104) FIG. 5, with Software previously installed programmed to control the operation of the system and to make calculations, measurements; acquisition of GPS coordinates, etc. The said Software will utilize its own communication protocol, using specific Bluetooth addresses and serial numbers in order to identify devices that are located in the same vehicle. Additionally, the said CPU (104) FIG. 5, will be programmed to monitor the status of other devices wirelessly in order to make sure the system is working properly.

As the core of the said Structural Body of the Drivers Alert Screen (123) FIG. 3 the said CPU (104) FIG. 5, controls the Internal Wireless Network (122-A), Internal Network Device (107) FIG. 5, Alert Button (110), Felony Report Button (110-D), Digital to Analog Converter (111), which is connected to the Speakers (121-A), which produce the High sound (121-B1), Medium Sound (121-B2) and the Low Sound (121-B3) FIG. 5. The said CPU (104) FIG. 5 will also process the information acquired from the GPS (105) and its Signal (105-A). Additionally the said CPU is connected to the Lights Controller (104-A) which controls the lights (132-A), (133-A), (134-A), (127-A), (128-A) FIG. 5 through the cables (126). The said CPU (104) is also connected and controls the RF Transceiver (108) which is connected to the Antenna (109) from which the signals are broadcasted to the External Wireless Network (122-B) FIG. 5. Finally, the Analog to Digital Converter (119) is also connected to the CPU in order to receive (125) the signal from the Microphone (121) FIG. 5.

The second Electronic Device will be:

The Collision Detector Device

This electronic device is located in two or more places outside the vehicles or loading trucks FIG. 2, FIG. 4, FIG. 11, FIG. 13, and its purpose is to detect and transmit the Automatic Collision Alarm Signal (135) FIG. 1. This signal will be produced and transmitted only when a collision occurs on the vehicle or truck with the device installed. It is a signal automatically triggered since it does not required any manual input from a person or driver.

The Collision Detector Device (140) FIG. 2, FIG. 4, comprises an Electronic Board (103) which makes up the Collision Detector Electronic Module (141) FIG. 4, which will be attached to the vehicle through the Fixer to the Car (106) FIG. 2 and will be powered through the Power Feeder Cable (101) and the Battery (102) FIG. 2, FIG. 4. Additionally it includes the Collision Detector Band (113) which detects strong pressures and transmits them through the Collision Detector Band Wires (114) FIG. 2, FIG. 4. to the Analog to Digital Converter (115) which transmits (125) the said signals to the CPU (116) which is programmed to analyze it and trigger the said Automatic Collision Alarm Signal (135) FIG. 1. If the signal detected represents a very strong pressure that can only happen on a collision. The said CPU (116) will then broadcast the signal through the Wireless Device Collision Detector (117). The Drivers Alert Screen FIG. 3 will then pick up the said signal through the Internal Wireless Network (122-A) FIG. 4, FIG. 5.

The Third Electronic Device will be:

The Structural Body of the Authority Alert Screen

The Structural Body of the Authority Alert Screen (124) FIG. 7 will be installed inside the Police Officer Vehicle (150) FIG. 13, mounted through the Screen Holders (112) FIG. 7, and will visible and reachable by the Police Officers FIG. 13.

The said Structural Body of the Authority Alert Screen (124) FIG. 7 will comprise the following 5 screen sections:

The first section will be used to receive reports from drivers reporting a felony (153) FIG. 7, as well as to receive GPS coordinates (107-B) and show them on a map in order to provide the exact location being reported, thus giving Police Officers and advantage to respond more efficiently. The second section will be the Alert Zone (Blue Light) (134-A) FIG. 7. The third section will be the Critical Zone (Yellow Light) (133-A) FIG. 7. The fourth section will be the Emergency Zone (Red Light) (132-A) FIG. 7. And finally, the fifth section will be the Drivers Collision (128) (Orange Light) FIG. 7. It is important to notice that the said Drivers Collision (128)(Orange Light) FIG. 7 will be activated only when a collision has occurred and the Automatic Collision Alarm Signal (135) FIG. 1. has been triggered.

Additionally, on the said Structural Body of the Authority Alert Screen (124) FIG. 7, there are 4 buttons. The first button will be the Lineal Authority Emergency Button (110-A) FIG. 7, FIG. 9 which will be used by the Police Officers to activate alerts and indicate to other drivers about the presence of minor incidents in the road, thus preventing other drivers from getting into an accident. At the same time this button (110-A) FIG. 7, will be used to make other drivers aware of the presence of Police Officers in the area so they can be ready to receive instructions from the said Police Officers. The second button will be the Signal Authority Pursuit Button (110-B) FIG. 7, FIG. 9 which will be used by police officers (142) to alert drivers of a pursuit in progress and to provide indications to nearby drivers (144) FIG. 12 during the said pursuit. When pressed by the Police Officers (142), the said button (110-B) FIG. 7, FIG. 9 will open a communication channel with the Nearby Drivers (144) FIG. 12 through their Body of the Drivers Alert Screen (123) FIG. 3 FIG. 11 thus giving the said Police Officers the ability to provide indications to the said Nearby Drivers. The said signal will have a reach shorter than one mile, since the intention is to notify only nearby drivers so they can take the necessary precautions and not get in the middle of the said pursuit such as pulling over on the streets where the pursuit is occurring FIG. 12. The third button will be the Traffic Stop Button (110-C) FIG. 7, FIG. 9 which will be used by the Police Officers when they perform a Traffic Stop (150) FIG. 13, FIG. 16 and wish to notify other drivers (131) FIG. 16, of the said procedure FIG. 13, FIG. 16. When pressing the said button, it will open a communication channel with the drivers with a Structural Body of the Drivers Alert Screen (123) FIG. 3, FIG. 11, and FIG. 16 thus providing the signals Authority Manual Signal (136) and the Lineal Voice Main Signal (137) FIG. 16. This way they will transmit signals through which they will be able to provide direct instructions to the drivers (131) FIG. 16 through the Speaker (121-A) FIG. 3. Additionally, the Police Officers (151) FIG. 14 will be able to use a Microphone Extension (121) FIG. 7 if they need to get off the Police Officer Vehicle (150) FIG. 14 by utilizing the Authority Wireless Microphone Extension (122) FIG. 14. Wireless Device Microphone (122-D) FIG. 8, which will include a Microphone Switch (120) connected to the Analog to Digital Converter (119) which transforms the analog signal to digital to transmit it (125) to the CPU (104) and then connect it to the Authority Wireless Device (122-C) in order to transmit the said signal to other devices through the Internal Wireless Network (122-A) FIG. 8. The fourth button will be the Felony Report Button (110-E) FIG. 7, FIG. 9. This button will be used by the Police Officers to respond to other drivers when they report a felony in progress. When pressed, the Police Officers (154) will open a communication channel between them and the driver (153) reporting the felony (156), (157) FIG. 17. This will be a direct communication between both parties, thus reducing the response time from the authority to provide the requested help. This procedure will be described in detail on the Felony Report Operation FIG. 17.

Additionally, the said Structural Body of the Authority Alert Screen (124) FIG. 7, comprises three Speakers (121-A) FIG. 7, FIG. 9, which will produce the sounds: High Sound (121-B1), Medium Sound (121-B2), Low Sound (121-B3), which will indicate the distance from the device emitting the alert and the said Structural Body of the Authority Alert Screen. The alerts that will be received by the Authority will be: the Automatic Collision Alarm Signal (135) FIG. 1, Manual drivers Signal (139) FIG. 15, and the Felony Report Signal (156) FIG. 17. The said sounds (121-B1), (121-B2), (121-B3) will be synced with the three screen sections (134-A), (133-A), (132-A) FIG. 7, with the purpose of providing more information and support to the drivers in order for them to make better decisions. Additionally, the said Structural Body of the Authority Alert Screen (124) FIG. 7 will include a Microphone (121) FIG. 7, which will be used by the Police Officers so they can speak to the drivers and to give them clear and precise instructions.

Inside the said Structural Body of the Authority Alert Screen (124) FIG. 7, there is the Authority Screen Electronic Module (124-A) FIG. 9, which is made up of the Electronic Board (103) and is powered by the Feeder Cable (101) and the Battery (102) FIG. 9.

The said Electronic Board (103) comprises a CPU (104) FIG. 9, with Software previously installed programmed to control the operation of the system and to make calculations, measurements; acquisition of GPS coordinates, etc. The said Software will utilize its own communication protocol, using specific Bluetooth addresses and serial numbers in order to identify devices that are located in the same vehicle. Additionally, the said CPU (104) FIG. 9, will be programmed to monitor the status of other devices wirelessly in order to make sure the system is working properly.

Additionally, the structure of the Internal Wireless Network (122-A), comprises the Internal Network Device (107) FIG. 9, which is connected to the CPU (104) FIG. 9, to which the Authority Traffic Stop Button (110-C), the Circular Signal Authority Pursuit Button (110-B) FIG. 9, the Lineal Authority Emergency Button (110-A) FIG. 9 and the Digital to Analog Converter (111) will be connected. To the said Digital to Analog Converter (111) send the signal (125) to the Speakers (121-A) and are connected from which the High sound (121-B1), Medium Sound (121-B2) and Low Sound (121-B3) FIG. 9 will be produced The said CPU (104) FIG. 9 will also process the information acquired from the GPS (105) and its signal (105-A), and will be connected to the Lights Controller (104-A) through the cables (126) which will activate the Red Light (132-A), Yellow Light (133-A), Blue Light (134-A) and the Orange Light (128-A) FIG. 9. The said CPU (104) FIG. 9 is also connected to the RF Transceiver (108) to which the Antenna (109) is connected to the External Wireless Network (122-B) FIG. 9. Additionally, the Microphone (121) is connected to the Analog to Digital Converter (119) which is connected to al CPU (104) FIG. 9.

The Fourth Electronic Device will be:

The Authority Wireless Control Unit Extension

Additionally, the Police Officers will be able to use the Authority Wireless Microphone Extension (122) FIG. 14 as a Microphone (121) FIG. 7 extension accessory when the Police Officers wish to get off the Police Officer Vehicle (150) FIG. 13, thus allowing them to keep the communication with the drivers by staying connected wirelessly FIG. 13, FIG. 14.

The Authority Wireless Microphone Extension (122) FIG. 14 system is made of the Authority Wireless Electronic Module Unit Extension (124-B) which will be embedded in the Electronic Board (103) FIG. 8 and will be powered by the Battery (102) FIG. 8 through the Power Feeder Cable (101).

When pressing the Microphone Switch (120) FIG. 8, FIG. 14 it will trigger a signal (125) to the Analog to Digital Converter (119), which will be immediately connected to the Authority CPU (118) which will be connected to the Internal Wireless Network (122-A) FIG. 8 through the Authority Wireless Device (122-C). This way the Structural Body of the Authority Alert Screen (124) FIG. 7, FIG. 9, FIG. 13 and the Authority Wireless Microphone Extension (122) FIG. 8, FIG. 14 will be connected.

Additionally, FIG. 6 and FIG. 10 represent the signal direction in the Drivers Alert Screen and the Authority Alert Screen Systems.

Operation—FIG. 1 Through FIG. 17

The Collision Awareness and Emergency Signal System will function through a device and 6 signal alarm buttons:

### Collision Detection Device

### Automatic Collision Alarm Signal

The collision detection system is designed to detect vehicle accidents (130) FIG. 1 and broadcast them to other vehicles (131) FIG. 1 with the purpose of alerting their drivers of the said accidents and their location, thus preventing further accidents. The said collision detection system comprises a Collision Detector Device (140) FIG. 2, FIG. 4, FIG. 6, FIG. 11, FIG. 13 which comprises a Collision Detector Band (113) FIG. 2, FIG. 11, FIG. 13, which is located on the surrounding areas of a vehicle FIG. 11, FIG. 13, and when pressure is applied on the said Collision Detector Band (113), it produces an analog signal that is transferred through the Collision Detector Band Signal Wires (114) FIG. 4, to an Analog to Digital Converter (115) FIG. 4, which is embedded in the Collision Detector Electronic Module (141) FIG. 4, with the purpose of converting the said analog signal to a digital format representing an Automatic Collision Alarm Signal (135) FIG. 1, which is received (125), by a programmable Microprocessor (116) FIG. 4. The said Microprocessor is programmed to analyze the signal and if there is any anomaly then a digital output representing an alarm is sent (125) to the Collision Detector Wireless Device (117) FIG. 4 which will process the data and send it to the Structural Body of The Driver Alert Screen (123) and the Drivers screen electronic Module (123-A) FIG. 3, FIG. 5, FIG. 11, wirelessly through the Internal Wireless Network (122-A) FIG. 4, FIG. 5, The said Internal Wireless Network is designed to have a predefined and programmable power in order to reach a long enough distance for any devices inside the same vehicle FIG. 11 to receive it but not too long to reach other vehicles. Additionally, the said Microprocessor (116) FIG. 4 is designed to include its serial number when establishing communication in order to prevent interference with the signals broadcasted from other vehicles. The said Driver Alert Screen (123) FIG. 3, FIG. 11, is located inside the vehicle visible and within reach of the driver and is designed to interact with the driver but also as the main element of the system. The said Driver Alert Screen (123) receives the said Automatic Collision Alarm trough the Internal Network Wireless Device (107) FIG. 5, which is connected to the Internal Wireless Network (122-A) FIG. 4, FIG. 5 and is received (125) by the CPU (104) FIG. 5 which is embedded in the Driver Screen Electronic Module (123-A) FIG. 5. When the said CPU processes the said Automatic Collision Alarm Signal (135) it broadcasts it to the External Wireless Network (122-B) FIG. 5 trough the RF Transceiver (108) FIG. 5 and Antenna (109) FIG. 5 alerting of the collision and at the same time transmitting GPS coordinates (105-A), obtained from the GPS Device (105) FIG. 5 indicating the Initial Collision Point (129) FIG. 1. When another Driver Alert Screen (123), located in another vehicle receives the said Automatic Collision Alarm Signal (135) and the coordinates of the said Initial Collision Point (129) FIG. 1, through the said Antenna (109) and RF Transceiver (108) FIG. 5, the data gets received by the said CPU (104) which transmits (125) a signal to the Display Controller (104-A) FIG. 5, indicating to activate the Driver Collision Light (128-A) trough the lights wires (126) FIG. 5, which emits an drivers collision light (orange color) (128) on the Drivers Alert Screen FIG. 3. Additionally, the said CPU (104) FIG. 5, reads the coordinates of its location from the GPS Device (105) FIG. 5 located on the same Driver Screen Electronic Module (123-A) FIG. 5, and compares them with the ones received on the said Automatic Collision Alarm Signal (135) in order to calculate the distance from the said Initial Collision Point (129) FIG. 1. If the distance calculated indicates the vehicle is located in the Emergency Zone (132) FIG. 1, then the Emergency Zone Light (132-A) FIG. 5, which emits a red light (132-A) gets activated FIG. 3. If the distance calculated indicates the vehicle is located in the Critical Zone (133) FIG. 1, then the Accident Critical Zone Light (133-A) FIG. 5, which emits a yellow light (133-A) gets activated FIG. 3. If the distance calculated indicates the vehicle is located in the Driver Alert Zone (134) FIG. 1, then the Accident Alert Zone Light (134-A) FIG. 5, which emits a blue light (134-A) gets activated FIG. 3. Additionally, the said CPU (104) FIG. 5, produces a digital signal sent (125) to the Digital to Analog Converter (111) FIG. 5 which produces an analog signal transmitted to the Speaker (121-A) FIG. 3, FIG. 5 to produce a Beeping Sound (121-B1, 121-B2, 121-B3) representing the distance from the source where the original signal (129) was produced. The frequency of the said Beeping Sound increases while the said location becomes closer and closer (121-B3, 121-B2, 121-B1), to the point when it becomes constant. When the location of the source of the signal is close but it is getting further and further then the frequency of the beeping sound decreases (121-B1, 121-B2, 121-B3), until it stops completely if the source of the signal is detected to be too far away or is no longer received.

### Emergency Alert System

### Drivers Manual Signal Button (110)

The emergency alert system is designed to help vehicle drivers (130-A) FIG. 15 to alert other drivers (131) FIG. 15 of an emergency that they should be aware of with the purpose of preventing an accident. The said emergency alert system comprises a Driver Alert Screen (123) FIG. 3 with an Emergency Button (110) FIG. 3, FIG. 5 that can be pressed by the said drivers to trigger a signal that will be received by the CPU (104) FIG. 5 which will process it and broadcast a Manual Driver Signal (139) FIG. 15, to the External Wireless Network (122-B) FIG. 5 trough the RF Transceiver (108) FIG. 5, and Antenna (109) FIG. 5, alerting other drivers and at the same time transmitting GPS coordinates (105-A) obtained from the GPS Device (105) FIG. 5 indicating the Alerting Vehicle Location (130-B) FIG. 15. When another Driver Alert Screen (123) located in another vehicle (131) FIG. 15, receives the said Manual Driver Signal (139) and the coordinates (105-A) of the said Alerting Vehicle Location (130-B) through the said Antenna (109) and RF Transceiver (108) FIG. 5, the data gets received by the said CPU (104) which reads the coordinates of its location (130-B) FIG. 15, from the GPS Device (105) FIG. 5 located on the same Driver Alert Screen and compares them with the ones received on the said Manual Driver Signal (139) in order to calculate the distance from the said Initial Alerting Vehicle Location (130-B). If the distance calculated indicates the vehicle is located in the Emergency Zone (132) FIG. 15, the said CPU (104) transmits (125) a signal to the Display Controller (104-A) indicating to activate Emergency Zone Light (132-A) FIG. 5 which emits a red light (132-A) gets activated FIG. 3. If the distance calculated indicates the vehicle is located in the Critical Zone (133) FIG. 15, then the Critical Zone Light (133-A) FIG. 5 which emits a yellow light (133-A) gets activated FIG. 3. If the distance calculated indicates the vehicle is located in the Alert Zone (134) FIG. 15, then the Alert Zone Light (134-A) FIG. 5 which emits a blue light (134-A) gets activated FIG. 3. Additionally, the said CPU (104) FIG. 5 produces a digital signal sent to (125) the Digital to Analog Converter (111) FIG. 5 which produces an analog signal transmitted to the Speaker (121-A) to produce a Beeping Sound (121-B1, 121-B2, 121-B3) FIG. 3, FIG. 5 representing the distance from the source where the original signal was produced (130-B). The frequency of the said Beeping Sound increases while the said location becomes closer and closer (121-B3, 121-B2, and 121-B1) to the point (130-B) FIG. 15 when it becomes constant. When the location of the source of the signal is close but it is getting further and further then the frequency of the beeping sound decreases (121-B1, 121-B2, and 121-B3) until it stops completely if the source of the signal (130-B) FIG. 15 is detected to be too far away or is no longer received. As a side note, it is important to know that the main difference when a Driver Alert Screen (123) receives the Automatic Collision Alarm Signal (135) FIG. 1 or the Manual Driver Signal (139) FIG. 15 is that the said Automatic Collision Alarm Signal activates the Orange Light (128-A) Through the light wires (126) FIG. 5 which emits an Drivers Collision light (orange color) (128) FIG. 3 in order to get the drivers' attention since the signal most likely represents a more dangerous situation.

### Authority Traffic Stop Awareness System

### Authority Manual Signal (110-C) Button

The Authority Traffic Stop Awareness System is designed to help police officers (150), (151) FIG. 13, FIG. 14 to alert drivers (131) FIG. 16 of a traffic routine stop (150) FIG. 13 in the emergency lines (148), (149) FIG. 1, FIG. 13, that they should be aware of with the purpose of preventing an accident and for protection of the said police officers. The said Authority Traffic Stop Awareness System comprises a Authority Control Screen (124) FIG. 7, FIG. 13 with a Authority Traffic Stop Button (110-C) FIG. 7, FIG. 9, that can be pressed by the said police officers to trigger a signal that will be received by the CPU (104) FIG. 9 which will process it and broadcast an Authority Manual Signal (136) FIG. 16 to the External Wireless Network (122-B) FIG. 9 trough the RF Transceiver (108) FIG. 9 and Antenna (109) FIG. 9 alerting drivers (131) FIG. 16 and at the same time transmitting GPS coordinates obtained from the GPS Device (105) FIG. 9 indicating the Alerting Vehicle Location (150), (130-B) FIG. 16. When a Structural Body of the Driver Alert Screen (123), located in another vehicle (131) FIG. 16 receives the said Authority Manual Signal (136) FIG. 16 and the coordinates (105-A) of the said Alerting Vehicle Location (130-B) FIG. 16, through the said Antenna (109) FIG. 5, and RF Transceiver (108) FIG. 5, the data gets received by the said CPU (104) FIG. 5, which reads the coordinates of its location from the GPS Device (105) FIG. 5 located on the same Structural Body Driver Alert Screen (123), and compares them with the ones received on the said Authority Manual Signal (136) in order to calculate the distance from the said Initial Alerting Vehicle Location (150), (130-B) FIG. 16. If the distance calculated indicates the vehicle is located in the Emergency Zone (132) FIG. 16 the said CPU (104) FIG. 5 transmits (125) a signal to the Display Controller (104-A) FIG. 5, indicating to activate Red Light (132-A) FIG. 5 which emits a red light (132-A) gets activated FIG. 3. If the distance calculated indicates the vehicle is located in the Critical Zone (133) FIG. 16 then the Critical Zone Light (133-A) FIG. 5, which emits a yellow light (133-A) gets activated FIG. 3. If the distance calculated indicates the vehicle is located in the Alert Zone (134) FIG. 16 then the Alert Zone Light (134-A) FIG. 5 which emits a blue light (134-A) gets activated FIG. 3. Additionally, at the same time, regardless of the distance from the said Alerting Vehicle Location (150), (130-B) a Red-Blue Color Light (127-A) through the light wires (126) activated a Stroboscopic Light (127) FIG. 3 gets activated in order to get the driver's attention and to indicate the origin of the signal comes from a police officer (150) FIG. 13, FIG. 16. Additionally, the said CPU (104) produces a digital signal sent (125) to the Digital to Analog Converter (111) FIG. 5 which produces an analog signal transmitted to the Speaker (121-A) FIG. 3, FIG. 5 to produce a Beeping Sound (121-B1, 121-B2, 121-B3) representing the distance from the source where the original signal was produced. The frequency of the said Beeping Sound increases while the said location becomes closer and closer (121-B3, 121-B2, and 121-B1) to the point when it becomes constant. When the location of the source of the signal is close but it is getting further and further then the frequency of the beeping sound decreases (121-B1, 121-B2, 121-B3), until it stops completely if the source of the signal is detected to be too far away or is no longer received.

### Authority Emergency Alert System

### Lineal Authority Emergency Button (110-A)

The Authority Emergency Alert System is designed to help police officers (150) FIG. 13, (151) FIG. 14 to alert drivers (131) FIG. 16 of an emergency in the road that they should be aware of with the purpose of preventing an accident and for protection of the said police officers. The said Authority Emergency Alert System comprises an Authority Control Screen (124) FIG. 7, FIG. 13 with an Emergency Button (110-A) FIG. 7, FIG. 9 that can be pressed by the said police officers to trigger a signal that will be received by the CPU (104) FIG. 9, which will process it and broadcast an Authority Manual Signal (136) FIG. 16, to the external Wireless Network (122-B) FIG. 9, through the RF Transceiver (108) FIG. 9 and antenna (109) FIG. 9, alerting drivers (131) FIG. 16, and at the same time transmitting GPS coordinates obtained from the GPS Device (105) FIG. 9, indicating the alerting vehicle location (150), (130-B) FIG. 16. The said Authority Emergency Alert System also has a Microphone (121) FIG. 7, FIG. 9 that can be used by the police officer as an option to communicate with the drivers (131) FIG. 16. The said Microphone (121) will be activated when the button (110-A) FIG. 3, FIG. 9, is pressed and sends (125) the analog signal to the Analog to Digital Converter (119) FIG. 9 which converts it to a digital format and sends it (125) to the said CPU (104) FIG. 9. As an auxiliary item, the police officer (151) FIG. 14 can use an Authority Wireless Microphone Extension (122) FIG. 14 in order to use the system wirelessly when stepping out of the Police Officer Vehicle (150) FIG. 13. When the police officer (151) presses the Microphone Switch (120) FIG. 14, FIG. 8 a signal originated from the Wireless Device Microphone (122-D) FIG. 8 is received by the Authority Analog to Digital Converter (119) FIG. 8 which converts the analog signal to a digital format which is sent (125) to the Authority Microprocessor (118) FIG. 8 which transmits the said signal to the Authority Control Screen (124) FIG. 7, FIG. 13 through the Authority Wireless Device (122-C) FIG. 8 which is connected to the Internal Wireless Network (122-A) FIG. 8, FIG. 9. When the said Authority Control Screen (124) receives the said signal through the Internal Network Wireless Device (107) FIG. 9 it gets received by the said CPU (104) FIG. 9. When the said CPU receives the said signal triggered by the said CPU and the audio they both get processed and broadcasted as a Lineal Voice Main Signal (137) FIG. 16 to the External Wireless Network (122-B) FIG. 9 trough the RF Transceiver (108) FIG. 9 and Antenna (109) FIG. 9 alerting the drivers and at the same time transmitting GPS coordinates obtained from the GPS Device (105) FIG. 9 indicating the Alerting Vehicle Location (150), (130-B) FIG. 16. When a Driver Alert Screen (123) located in another vehicle receives the said Lineal Voice Main Signal (137) FIG. 16 and the coordinates of the said Alerting Vehicle Location through the said Antenna and RF Transceiver the data gets received by the said CPU (104) FIG. 5 which reads the coordinates of its location from the GPS Device (105) FIG. 5 located on the same Driver Alert Screen (123) FIG. 3, FIG. 5, and compares them with the ones received on the said Lineal Voice Main Signal (137) in order to calculate the distance from the said Initial Alerting Vehicle Location (150), (130-B) FIG. 16. If the distance calculated indicates the vehicle is located in the Emergency Zone (132) FIG. 16 the said CPU transmits (125) a signal to the Display Controller (104-A) indicating to activate Red Light (132-A) FIG. 5 which emits a red light (132-A) gets activated FIG. 3. If the distance calculated indicates the vehicle is located in the Critical Zone (133) FIG. 16 then the Critical Zone Light (133-A) FIG. 5 which emits a yellow light (133-A) gets activated FIG. 3. If the distance calculated indicates the vehicle is located in the Alert Zone (134) FIG. 16 then the Alert Zone Light (134-A) FIG. 5 which emits a blue light (134-A) gets activated FIG. 3. Additionally, at the same time, regardless of the distance from the said Alerting Vehicle Location, a Stroboscopic Light (127) FIG. 3 gets activated in order to get the driver's attention and to indicate the origin of the signal comes from a police officer. Additionally, the said CPU (104) produces a digital signal sent to the Digital to Analog Converter (111) FIG. 5 which produces an analog signal transmitted to the Speaker (121-A), to produce a Beeping Sound (121-B1, 121-B2, 121-B3) FIG. 3, FIG. 5, representing the distance from the source where the original signal was produced. The frequency of the said Beeping Sound increases while the said location becomes closer and closer (121-B3, 121-B2, and 121-B1) to the point when it becomes constant. When the location of the source of the signal is close but it is getting further and further then the frequency of the beeping sound decreases (121-B1, 121-B2, 121-B3) FIG. 3, FIG. 5, until it stops completely if the source of the signal is detected to be too far away or is no longer received. If the Authority voice originated from the Microphone (121) FIG. 7, FIG. 9 or from the Authority Wireless Microphone Extension (122) FIG. 14 is received the said beeping sound is stopped and the said voice is produced on the said Speakers (121-A) FIG. 3, with the purpose of communicating the said police officer instructions to all the receiving drivers (131) FIG. 16.

### Authority on Pursuit Awareness System

### Circular Signal Authority Pursuit Button (110-B)

The Authority on Pursuit Awareness System is designed to help police officers in an Authority Car on Pursuit (142) FIG. 12 to alert through the blocks (147) Nearby Drivers (144) FIG. 12 of a pursuit in the road (146) that they should be aware of with the purpose of preventing an accident with the Vehicle Under Pursuit (143) FIG. 12 or the same police officers involved. The said Authority on Pursuit Awareness System comprises an Authority Control Screen (124) FIG. 7, FIG. 13 with a Circular Authority Emergency Button (110-B) FIG. 7, FIG. 9 that can be pressed by the said police officers to trigger a pursuit signal that will be received by the CPU (104) FIG. 9, which will process it and broadcast an vehicle under pursuit signal (145) FIG. 12 to the external wireless network (122-B) FIG. 9, Through the RF Transceiver (108) FIG. 9 and antenna (109) FIG. 9 Alerting Drivers (144) FIG. 12. The said Authority on pursuit awareness System also has a Microphone (121) FIG. 7, FIG. 9 that can be used by the police officer to communicate with the drivers. The said Microphone (121) is activated when the Button (110-B) is pressed. This sends (125) the analog signal to the Analog to Digital Converter (119) FIG. 9 which converts it to a digital format and sends it (125) to the said CPU (104) FIG. 9. When the said CPU receives the said signal triggered by the said CPU and the audio they both get processed and broadcasted as a Vehicle Under Pursuit Signal (145) FIG. 12 and as a Circular Voice Main Signal (138) FIG. 12 to the External Wireless Network (122-B) FIG. 9 trough the RF Transceiver (108) FIG. 9 and Antenna (109) FIG. 9 utilizing a low power output in order to reach other drivers within a programmable distance which is half a mile by default from the said Authority Car on Pursuit (142). When a Driver Alert Screen (123) FIG. 3 located in another vehicle (144) receives the said Circular Voice Main Signal (138) and the said Vehicle Under Pursuit Signal (145) through said Antenna (109) and RF Transceiver (108) FIG. 5 the data gets received by the said CPU which transmits (125) a signal to the Display Controller (104-A) indicating to activate a Stroboscopic Light (127) FIG. 3 in order to get the driver's attention and to indicate the origin of the signal comes from a police officer. If voice originated from the Microphone (121) FIG. 7, FIG. 9 or from the Authority Wireless Microphone Extension (122) FIG. 14 is received voice is produced on the said Speakers (121-A) FIG. 3, FIG. 7 with the purpose of communicating the said police officer instructions to all the receiving drivers (144).

### Felony Report Procedure

### Felony Report (110-D) and Authority Felony Report Button (110-E)

The Felony Report Procedure is designed to help a Vehicle Reporting Felony (153) FIG. 17 to communicate efficiently with a police officer in a Nearby Police Officer Car (154) FIG. 17 of a Felony Event (158) FIG. 17 with the purpose of fighting crimes more efficiently by reducing the response time of police officers. The said Felony Report Procedure comprises a Driver Alert Screen (123) FIG. 3 with an Felony Report Button (110-D) FIG. 3, FIG. 5 that can be pressed by the said drivers to trigger a signal that will be received by the CPU (104) FIG. 5 which will process it and broadcast a Felony Report Signal (156) FIG. 17, to the External Wireless Network (122-B) FIG. 5 trough the RF Transceiver (108) FIG. 5, and Antenna (109) FIG. 5, and at the same time transmitting GPS coordinates (105-A) obtained from the GPS Device (105) FIG. 5 indicating the location of the Vehicle Reporting Felony (153) FIG. 17, which is estimated to be a very close proximity from the Felony Location (158) FIG. 17. Multiple police officers located in the area receive the said Felony Report Signal (156) and the coordinates (105-A) of the said Vehicle Reporting Felony through the said Antenna (109) and RF Transceiver (108) FIG. 5, the data gets received by the said CPU (104) which reads the coordinates of its location from the GPS Device (105) FIG. 9 located on the same Authority Alert Screen FIG. 7 and compares them with the ones received on the said Felony Report Signal in order to calculate the distance from the said Felony Report Location (153). If the distance calculated indicates the police officer is the closest one (154) FIG. 17 the said CPU sends a signal to the Display Controller (107-A) FIG. 9 which will turn the Display (107-B) FIG. 7, FIG. 9, on and will show a map (107-B) FIG. 7, indicating the route between the said officer (154) and the estimated Felony Report Location (158) FIG. 17. The said officer (154) FIG. 17 can press the Authority Felony Report Button (110-E) FIG. 7, FIG. 9, which will send a signal to the CPU (104) and then trigger a communication channel (157) FIG. 17 through which the said Police Officer (154) will be able to have a conversation with the person in the said Vehicle Reporting Felony (153) FIG. 17 in order to get more details about the felony and the said Felony Location (158) FIG. 17.

After everything previously presented a specialist on the matter will probably find it easy to understand the objective of the invention, which is not meant to be limited, since objectives of this new invention have been clearly reached. Its function and structure have been shown, which can be flexible and take new concepts while keeping the fundamentals. This invention covers all possible essential changes and scope of the following described claims.

I claim:

1. A manually activated emergency alert apparatus which comprises a screen structure device installed inside an automobile in a location visible and reachable by the driver, which comprises an activation button designed to generate an electronic signal when pressed and then emits a digital signal representing an emergency alert including the GPS coordinates which is broadcasted to a radio frequency network through a transceiver with the purpose of communicating the said emergency alert to equal devices as the said screen structure device but located on other nearby vehicles and at the same time provide the location where the signal is generated for distance calculation purposes; The said screen structure device also includes a set of speakers which produce a beeping sound with a variable frequency with a set of lights which together and synced represent a type of alert and the distance from an equal device producing it; the said distance from the source of the alert is represented by increasing the frequency of the beeping sound and simultaneously switching colors on the said screen from right to left as the distance becomes shorter, while the opposite, a decreasing frequency of the beeping sound and simultaneously switching colors on the said screen from left to right as the distance becomes longer; which is the same one used to broadcast alert signals to equal devices meant to be activated by a driver or passenger by pressing different buttons located on the said screen structure which trigger electronic signals.

2. A collision detection device embedded in a pressure detection band which is installed on the surroundings of an automobile and works by detecting high pressure on it and converting it to a digital format with the purpose of transmit it through the internal wireless network to the screen structure device, thus allowing a way to automatically generate an emergency signal without the need of a person to activate it. This type of alarm is indicated with a different type of color displayed on the said screen structure device described on claim 1 in order to communicate to the drivers in the area that an actual car accident has occurred.

3. A screen structure device installed inside police officer vehicles in a location visible and reachable by the driver and passenger, which comprises a set of buttons designed to generate electronic signals when pressed which at the same time retrieves the location coordinates through a GPS device and then emits at least one digital signal representing a type of alert like a police inspection routine, an emergency or accident on the road and vehicle pursuit in progress; The selected type of signal and the said location coordinates are broadcasted to a radio frequency network through a transceiver with the purpose of communicating the said emergency alert to equal devices as the said screen structure device but located on other nearby vehicles and at the same time provide the location where the signal is generated for distance calculation purposes; The said screen structure device also includes a set of speakers which produce a beeping sound with a variable frequency combined with a set of lights which together represent a type of alert and the distance from an equal device producing it, calculated by a CPU which receives GPS coordinates along with the data representing the said alert received through a radio frequency transceiver connected to a privately defined network. The distance from the source of the alert is represented by increasing the frequency of the beeping sound and simultaneously switching colors on the said screen from right to left as the distance becomes shorter, while the opposite, a decreasing frequency of the beeping sound and simultaneously switching colors on the said screen from left to right as the distance becomes longer, which is the same one used to broadcast alert signals to equal devices meant to be activated by a driver or passenger by pressing different buttons located on the said screen structure which trigger electronic signals.

4. A manually activated emergency alert apparatus described on claim 1, further holds a button which when pressed by a driver or passenger triggers a illicit activity signal, appends GPS coordinates and broadcast it to a radio frequency network which can only be received by screen structure devices installed inside of the police officer vehicles; which the police officers make contact with the reporting person and open a voice communication channel through the use of a microphone and speakers which are installed on the said screen structure device used by police officers as well as on the ones used by drivers.
